(19) United States
(12) Patent Application Publication
(10) Pub. No.: US 2024/0127192 A1
(43) Pub. Date: Apr. 18, 2024

(54) COMPUTER-IMPLEMENTED METHOD AND SYSTEM FOR SCHEDULING PET WELLNESS

(71) Applicants: Michael Robert Otten, Johannesburg (ZA); Nicole Roseline Dessington, Johannesburg (ZA)

(72) Inventors: Michael Robert Otten, Johannesburg (ZA); Nicole Roseline Dessington, Johannesburg (ZA)

(21) Appl. No.: 18/547,755

(22) PCT Filed: Feb. 25, 2022
(86) PCT No.: PCT/IB2022/051678

§ 371 Date: Aug. 24, 2023

(30) Foreign Application Priority Data
Feb. 26, 2021 (ZA) 2021/01311

(51) Int. Cl. G06Q 10/1093; G06Q 30/0207; G06Q 30/0601; G06Q 40/08

(52) U.S. Cl. CPC G06Q 10/1095; G06Q 30/0207; G06Q 30/0641; G06Q 40/08

(57) ABSTRACT

A computer-implemented method, a system, and a computer program product are described for scheduling pet wellness. The method includes creating a pet profile including attributes configured to define a pet type and a pet age with the pet profile linked to a pet insurance service. The method includes providing a graphical user interface component in the form of a wheel having a plurality of navigation segments, with each segment providing a category of a wellness task navigating to a task window, with the wheel component providing a progression around the wheel component by completion of the tasks in a recommended time period. The task windows integrate to an insurance claim input for a cost of the service provider or purchased product.

### CROSS-REFERENCE TO RELATED APPLICATIONS

This application claims priority from South African provisional patent application number 2021/01311 filed on 26 Feb. 2021, which is incorporated by reference herein.

### FIELD OF THE INVENTION

This invention relates to pet wellness scheduling and, in particular, to computer-implemented scheduling of pet wellness.

### BACKGROUND TO THE INVENTION

Wellness programs are known for humans to promote healthy behaviour. These are often provided by medical insurance or medical aid companies to promote healthier habits such as fitness and diet in humans.

Known human wellness programs are provided via a web based or mobile application for prompting and recording healthy activities that may be incorporated into a reward scheme.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with an aspect of the present invention there is provided a computer-implemented method for scheduling pet wellness, comprising: creating a pet profile including attributes configured to define a pet type and a pet age, wherein the pet profile is linked to a pet insurance service; providing a graphical user interface (GUI) component in the form of a wheel having a plurality of navigation segments, with each segment providing a category of a wellness task navigating to a task window, with the wheel component providing a progression around the wheel component by completion of the tasks in a recommended time period; wherein the categories of wellness tasks include: an appointment category that has a task window that navigates to a selection of approved wellness service providers required for a task; and a product application category that has a task window that navigates to an e-commerce store for purchase of a required product for a task; and wherein the task windows integrate to an insurance claim input for a cost of the service provider or purchased product.

The wheel component may represent a stage of life appropriate for the pet profile, with segments of the wheel configured for the stage of life of the pet type. The method may repeat a presentation of the wheel component of a stage of life appropriate for the pet profile according to an age provided in the pet profile. The method may provide a next stage of life wheel component on completion of an earlier stage of life wheel and according to an age provided in the pet profile. The wheel component may represent a first year of life and the appointment categories of wellness tasks may include timed vaccination appointments. The method may include updating the pet profile after completion of a wellness task.

The method may integrate a reward scheme and including a reward after completion of a wellness task. The method may include navigating to a selection of approved wellness service providers required for a task based on a location service of a mobile device at which the method is carried out.

An appointment category may include one or more of the group of: a health check appointment, a vaccination appointment, a preventative treatment appointment, a sterilization appointment, a dental appointment, and a therapy appointment.

A product application category may include one or more of the group of: a topical anti-parasite product application, an internal anti-parasite product application, a grooming product application, a supplement product application.

In accordance with another aspect of the present invention there is provided a system for scheduling pet wellness, including a computing device including a memory for storing computer-readable program code and a processor for executing the computer-readable program code, the computing device comprising: a pet profile component for creating a pet profile including attributes configured to define a pet type and a pet age, wherein the pet profile is linked to a pet insurance service; a graphical user interface (GUI) wheel providing component for providing a graphical user interface component in the form of a wheel having a plurality of navigation segments, with each segment providing a category of a wellness task navigating to a task window, with the wheel component providing a progression around the wheel component by completion of the tasks in a recommended time period; wherein the categories of wellness tasks include: an appointment category provided by an appointment component that provides a task window that navigates to a selection of approved wellness service providers required for a task; and a product application category provided by a product application component that provides a task window that navigates to an e-commerce store for purchase of a required product for a task; and wherein the task windows integrate to an insurance claim component for input for a cost of the service provider or purchased product.

The wheel component may represent a stage of life appropriate for the pet profile, with segments of the wheel component configured for the stage of life of the pet type.

The computing device may include a profile updating component for updating the pet profile after completion of a wellness task.

The system may include one or more servers including a memory for storing computer-readable program code and a processor for executing the computer-readable program code, the one or more servers providing: an insurance service component; an e-commerce store service component; and an approved wellness service provider network service component.

The computing device may include a reward component for integrating a reward scheme and including a reward after completion of a wellness task. The system may include a server providing a rewards scheme service.

The computing device may include a navigation component for providing navigating to a selection of approved wellness service providers required for a task based on a location service of a mobile device at which the method is carried out.

The system may provide integration to a map server for providing lookup and navigation for the navigation component.

In accordance with a further aspect of the invention there is provided a computer program product for scheduling pet wellness comprising a computer-readable medium having stored computer-readable program code for performing the steps of: creating a pet profile including attributes configured to define a pet type and a pet age, wherein the pet profile is linked to a pet insurance service; providing a graphical user interface component in the form of a wheel component having a plurality of navigation segments, with each segment providing a category of a wellness task navigating to a task window, with the wheel component providing a progression around the wheel component by completion of the tasks in a recommended time period; wherein the categories of wellness tasks include: an appointment category that has a task window that navigates to a selection of approved wellness service providers required for a task; and a product application category that has a task window that navigates to an e-commerce store for purchase of a required product for a task; and wherein the task windows integrate to an insurance claim input for a cost of the service provider or purchased product.

Further features provide for the computer-readable medium to be a non-transitory computer-readable medium and for the computer-readable program code to be executable by a processing circuit.

Embodiments of the invention will now be described, by way of example only, with reference to the accompanying drawings.

### BRIEF DESCRIPTION OF THE DRAWINGS

In the drawings:

FIG. 1 is a block diagram showing an example embodiment of the described system;

FIG. 2 is a flow diagram showing an example embodiment of the described method;

FIG. 3 is a schematic diagram showing an example embodiment of the described method;

FIG. 4 is a block diagram showing an example embodiment of the described system;

FIGS. 5A-5AA are schematic diagrams illustrating an example embodiment of a graphical user interface for the described system; and

FIG. 6 illustrates an example of a computing device in which various aspects of the disclosure may be implemented.

### DETAILED DESCRIPTION WITH REFERENCE TO THE DRAWINGS

The described method and system provide pet wellness scheduling that may be provided by a computer application to schedule and motivate pet wellness whilst combining with an insurance service. The pet wellness scheduling is based on a pet profile having attributes that capture at least a pet's type and age and optionally other attributes such as breed, weight and the like. The computer application may be for a mobile computing device, or may alternatively be provided via a web application or for a non-mobile computing device.

The pet wellness scheduling application may require a user, such as a pet owner, to sign up/register including linking the registration to a pet insurance policy. Signing up for the pet wellness scheduling application may include creating a pet profile associated with each pet of a user and based on information input by the user including the attributes referred to above.

The pet wellness scheduling method and system provide a graphical user interface (GUI) including a component in the form of a wheel having a plurality of navigation segments, with each segment providing a category of a wellness task. Selecting a segment via the GUI navigates to a task window providing functionality for a task that is required to be completed for the wellness of the pet. The segments provide a schedule of tasks that are required or recommended and may include recommended time periods for the task. Progression around the wheel by completion of the tasks may prompt the tasks to be carried out in a recommended time period.

The GUI wheel component represents a stage of life appropriate for the pet profile, with segments of the wheel configured for the stage of life of the pet type. Progression round the wheel may be repeated if the stage of life is still appropriate for the pet. Alternatively, a next stage of life wheel may be provided on completion of an earlier stage of life wheel. For example, for newly born pets, a GUI wheel component may be provided that represents a first year of life with scheduled wellness task timed vaccination appointments.

The categories of wellness tasks presented by each segment of the GUI wheel component include an appointment category, for example, for vet appointments for scheduled check-ups and vaccinations, therapy appointments, or grooming appointments. Appointment category tasks have a task window that navigates to a selection of approved wellness service providers required for the task. Navigating to a selection of approved wellness service providers required for a task is based on a location service of a computer device at which the method is carried out. This is particularly applicable to mobile computing devices which can provide the user with directions to the service provider whilst travelling.

The categories of wellness tasks presented by each segment of the GUI wheel component further include a product application category, for example, application of tick and flea products, deworming products, etc. Product application category tasks have a task window that navigates to an online store for purchase of a required product for a task. In some embodiments, the task window may navigate a user to a nearby pet store based on a location of the computer device at which the method is being carried out.

The pet profile is linked to an insurance policy of an insurance service provider and all claims and refunds under an insurance policy for the pet are incorporated into the scheduling application. A rewards scheme may also be incorporated into the scheduling application for rewarding the adherence to the schedule provided by the wheel. The reward scheme may serve as an incentive for the user to complete the tasks associated with the wellness of the pet.

The pet wellness scheduling application drives certain behaviour and rewards pet owners using the application based on their proactive measures to improve their pet's health and reduce insurance claims. The pet wellness scheduling application tracks and captures a pet's life stages and health cycle check-ups, which may be linked with a pet insurer and an e-commerce pet store.

The term “pet” as used herein should not only be limited to animals, such as cats and dogs, and should be widely interpreted to refer to birds, reptiles, fish or the like, being domesticated or tamed. It should further be appreciated that the “user” as used herein may refer to the owner/s and/or guardian/s of the pet.

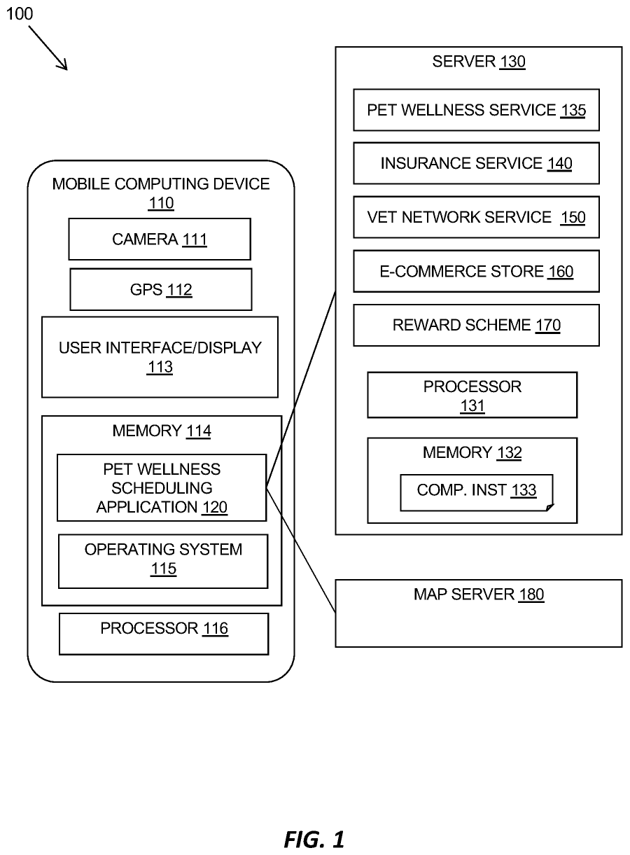

Referring to FIG. 1, a block diagram (100) shows an example embodiment of the described system. In this embodiment, a mobile computing device (110) is provided including a pet wellness scheduling application (120) providing the functionality as described herein.

The mobile computing device (110) may include a processor (116) for executing the functions of the pet wellness scheduling application (120), which may be provided by hardware or by software units executing on the mobile electronic device (110). The software units may be stored in a memory component (114) and instructions may be provided to the processor (116) to carry out the functionality of the described components in cooperation with an operating system (115) of the device. In some cases, for example in a cloud computing implementation, software units arranged to manage and/or process data on behalf of the mobile electronic device (110) may be provided remotely. Some or all of the components may be provided by a software application downloadable onto and executable on the mobile electronic device (110).

The mobile computing device (110) may include a user interface and display (113) for displaying and interacting with the pet wellness scheduling application (120). The mobile computing device (110) may also include a camera (111) and a geographical position service (GPS) component (112).

The pet wellness scheduling application (120) may have a backend pet wellness service (135) provided at a server (130) and integrated with one or more of an insurance service (140), a veterinary network service (150), an e-commerce store (160), and a reward scheme (170) that may be provided at the same server (130) or additional servers. The veterinary network service (150) may cooperate with a map server (180) providing navigation services. The one or more servers (130) may include a processor (131) for executing the functions the services, which may be provided by hardware or by software units. The software units may be stored in a memory component (132) and instructions (133) may be provided to the processor (131) to carry out the functionality. The server may be provided by any suitable computing device which is configured to perform the role of a server. The server may, for example, be maintained by a relevant insurance service provider. Alternatively, the server may be maintained by an independent third party.

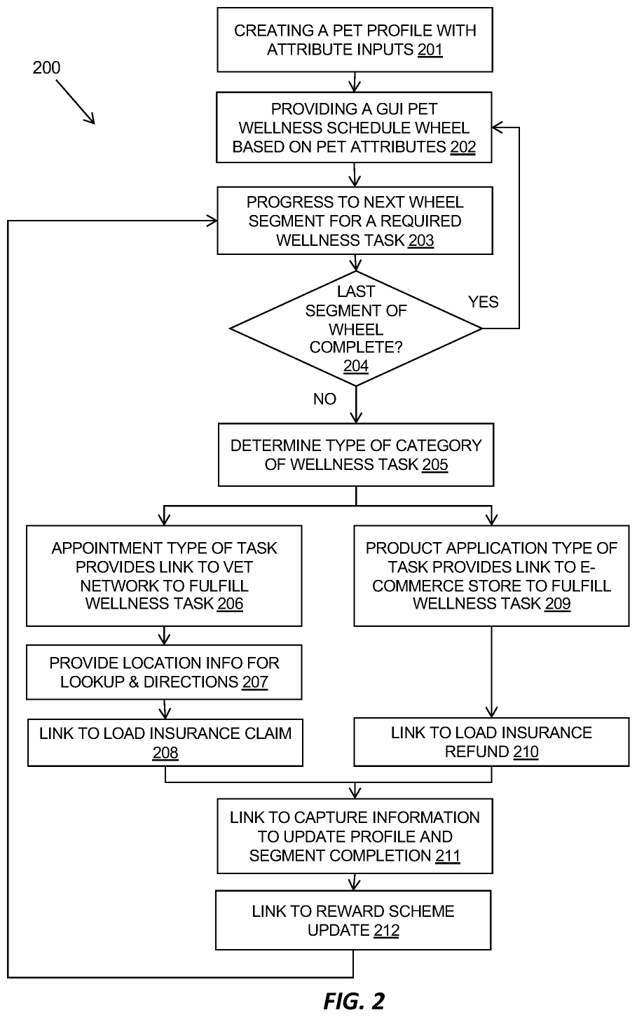

Referring to FIG. 2, a flow diagram (200) shows an example embodiment of the described computer-implemented method. The method may be provided by a pet wellness scheduling application (120) for a user and a corresponding method may be carried out at a backend server.

The method may create (201) a pet profile for a pet of the user based on attribute inputs. The attribute inputs may include information associated with the pet, such as, a profile name and photograph, a pet type, a pet breed, an age, and a weight. The attributes may be completed by answering displayed questions to capture the information. Health and wellness information may also be captured for the pet profile. The pet profile attributes may be updated when the user chooses and in response to prompts provided through use of the application functions. The method may be used for multiple pets of a same user by creating multiple pet profiles. The pet profile may be associated with a pet insurance policy provided by an insurance service.

The method provides (202) a GUI component in the form of a pet wellness schedule wheel representing a stage of life of the pet based on the pet profile attributes. The method may select the appropriate schedule for the stage of life from multiple wheel options. For example, there may be a first year of life stage, a young stage (for example, for puppies, kittens, etc.), an adult stage, and a senior stage. Each GUI wheel component has a series of navigation segments, with each segment providing a category of a wellness task that navigates the user to a task window. The term “window” includes a page or screen or other display component. The wheel promotes a progression around the wheel by completion of the tasks in a recommended order and time period.

The method may progress (203) to a next wheel segment for a required wellness task upon completion of the previous segment task or at a configured time. The method may determine (204) if the segment is the last segment of a wheel. If so, the method may determine if the same stage of life wheel is appropriate and may loop to repeat the wheel or start a new wheel for a later stage of life. Determining if the same stage of life wheel is appropriate or whether a new wheel is to be started for a later stage of life may depend on the updated attributes associated with the pet profile.

For a wheel segment, the method may determine (205) a type of category of the wellness task. These fall into two main categories: an appointment type task, and a product application type task.

An appointment type of task provides (206) a task window with a link to a veterinary or other service provider network so that an appointment can be booked to fulfil the task. This may include providing (207) location information for the user to lookup approved nearby service providers and to provide directions. The task window may also link (208) to an insurance scheme associated with the user to load an insurance claim for the appointment cost either as pre-approval or once the appointment has been completed.

A product application type of task provides (209) a task window with a link to an e-commerce store to fulfil the wellness task. The task window may also link (210) to an insurance scheme associated with the user to load an insurance refund for the product cost.

The method may provide a link to capture (211) updated profile information and to capture the completion of a segment. The method may also provide (212) a link to a reward scheme with rewards for completion of a segment. A link may be a navigation to another window, a control input, or other form of input. The method may then loop to progress (203) to a next wheel segment in the GUI wheel component for the current stage of life wheel. Progress around the GUI wheel component may be indicated to the user by means of the wheel rotating clockwise, the next wheel segment being highlighted, completed wheel segments being blocked out, or the like. This may enable a user to track progress and gain some insight into the next task.

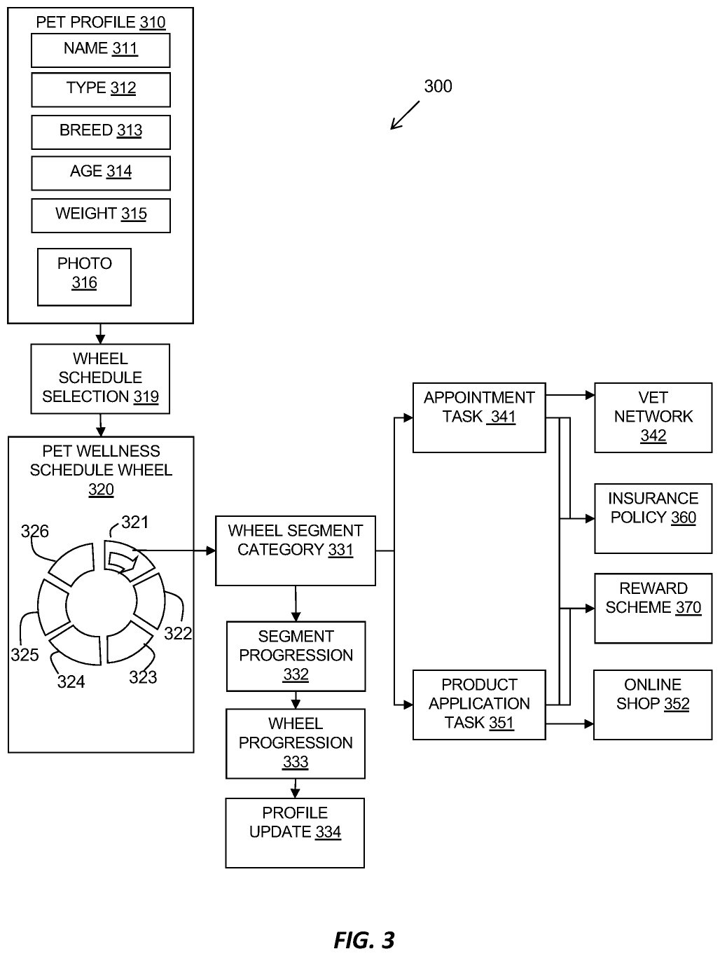

Referring to FIG. 3, a schematic diagram (300) illustrates the method of FIG. 2. A pet profile (310) may include a name (311), type (312), breed (313), age (314), weight (315), and photograph (316). The profile information may lead to a wheel schedule selection (319) for the appropriate stage of life of the pet. The pet wellness schedule GUI wheel component (320) includes a series of segments (321-326) that lead a user to progress around the wheel (320) in a clockwise manner.

Each segment (321-326) provided by the GUI wheel component (320) is associated with a wheel segment category (331) that may be an appointment task (341) or a product application task (351). The appointment task (341) ties to a veterinary network (342), an insurance policy (360), and a reward scheme (370). The product application task (351) ties to an e-commerce store (352), the insurance policy (360), and the reward scheme (370). The segments (321-326) of the GUI wheel component (320) prompt segment progression (332) around the wheel, wheel progression (333) to a next stage of life wheel, and profile updates (334).

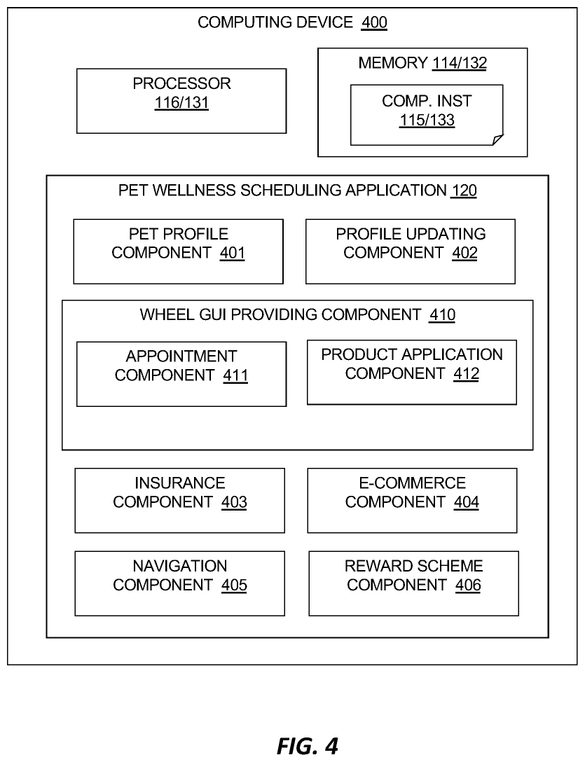

Referring to FIG. 4, a block diagram shows an example embodiment of a computing device (400) that may be the mobile computing device (110) or a server (130) as shown in FIG. 1 having a processor (116/131) for executing computer instructions (115/133) stored on memory (114/132). The computing device (400) may provide the functionality of the pet wellness scheduling application (120) that may be provided by software units. Corresponding components may be provided at the server (130) and the user application.

The pet wellness scheduling application (120) includes a pet profile component (401) for creating a pet profile including attributes configured to define a pet type and a pet age and a profile updating component (402) for updating the profile, with the pet profile is linked to a pet insurance service provided by an insurance component (403).

The pet wellness scheduling application (120) includes a GUI wheel providing component (410) for providing a GUI component in the form of a wheel having a plurality of navigation segments, with each segment providing a category of a wellness task navigating to a task window, with the wheel providing a progression around the wheel by completion of the tasks in a recommended time period. The GUI wheel providing component (410) includes an appointment component (411) for providing appointment tasks and that provides a task window that navigates to a selection of approved wellness service providers required for a task. The GUI wheel providing component (410) includes a product application component (412) that provides a task window that navigates to an e-commerce store for purchase of a required product for a task.

The pet wellness scheduling application (120) includes an e-commerce component (404) for integrating an e-commerce store functionality for purchasing required products for a wellness task. The pet wellness scheduling application (120) includes a reward scheme component (406) for integrating a reward scheme functionality for completion of a wellness task. The pet wellness scheduling application (120) includes a navigation component (405) for providing lookup and navigation for integration with the appointment component (411).

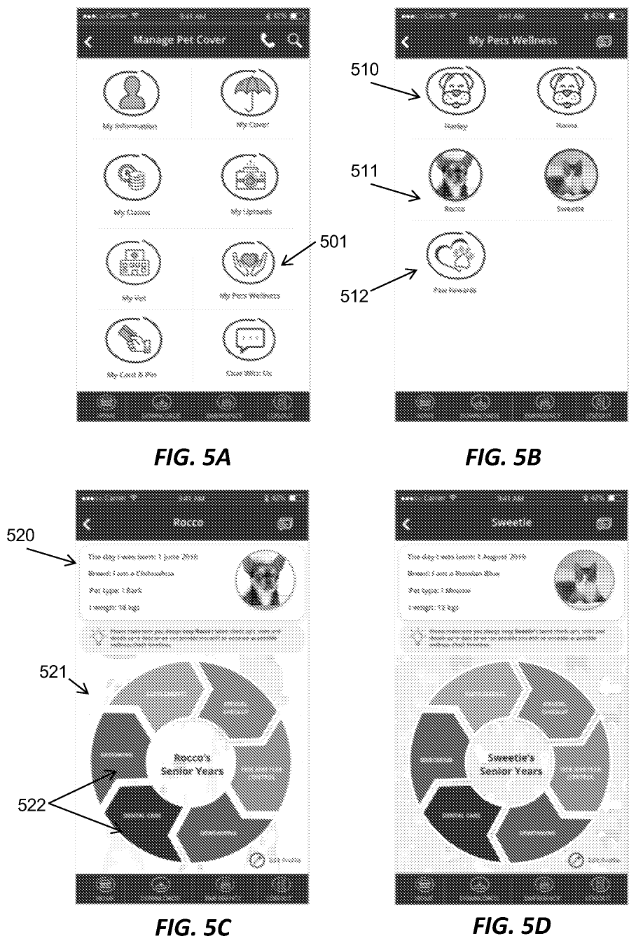

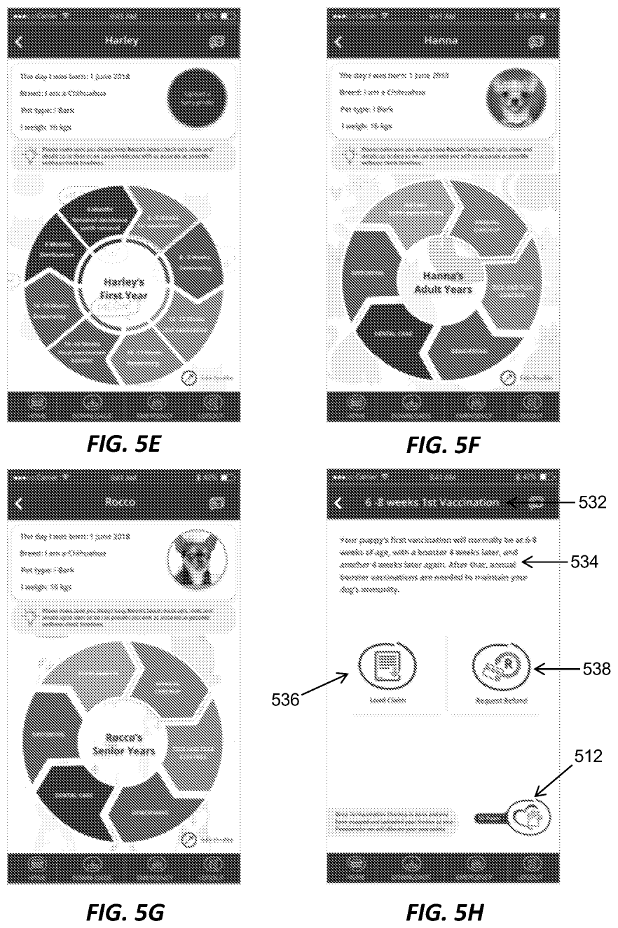

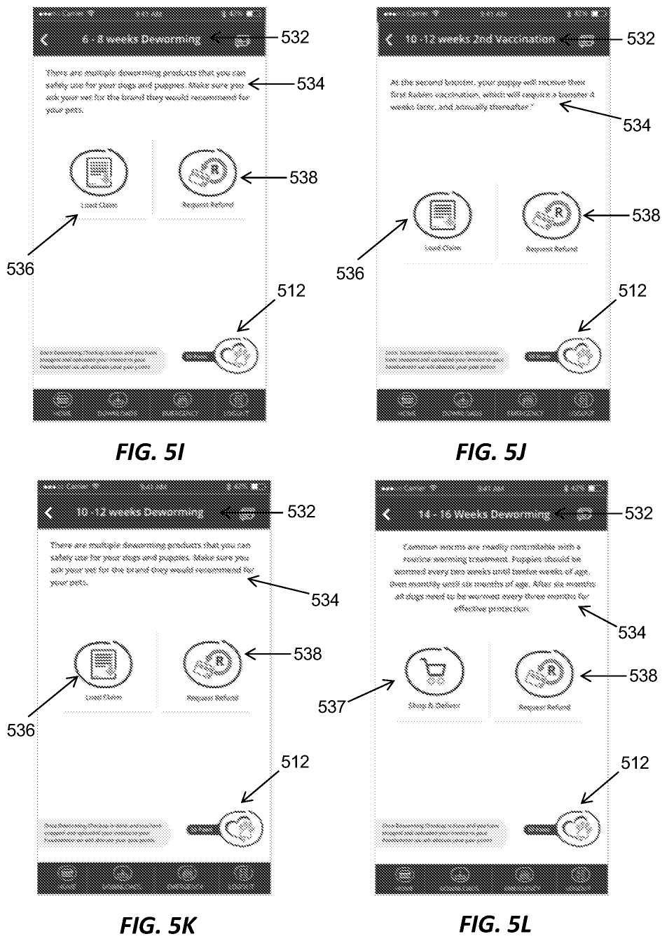

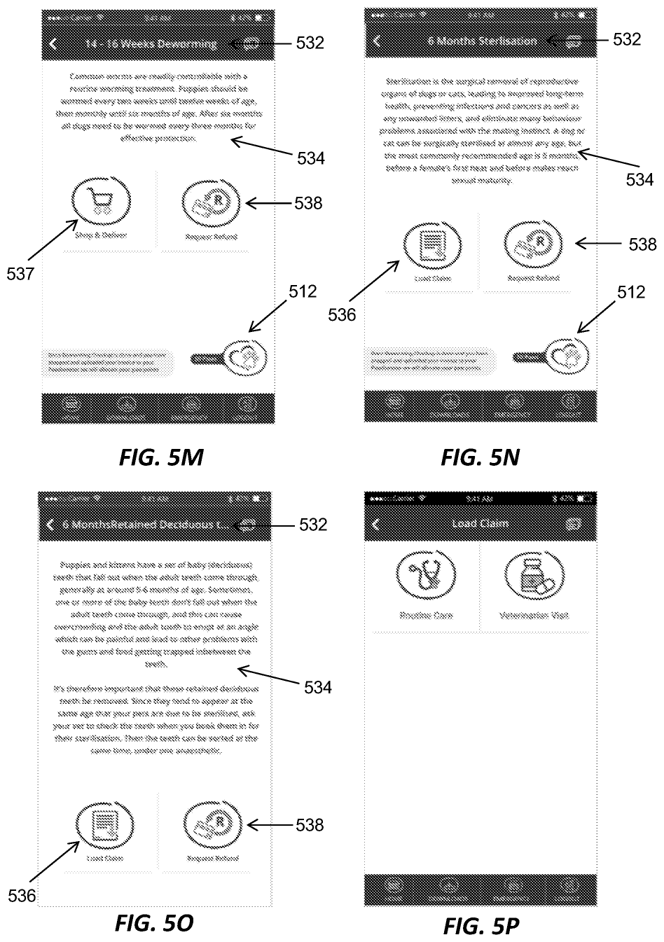

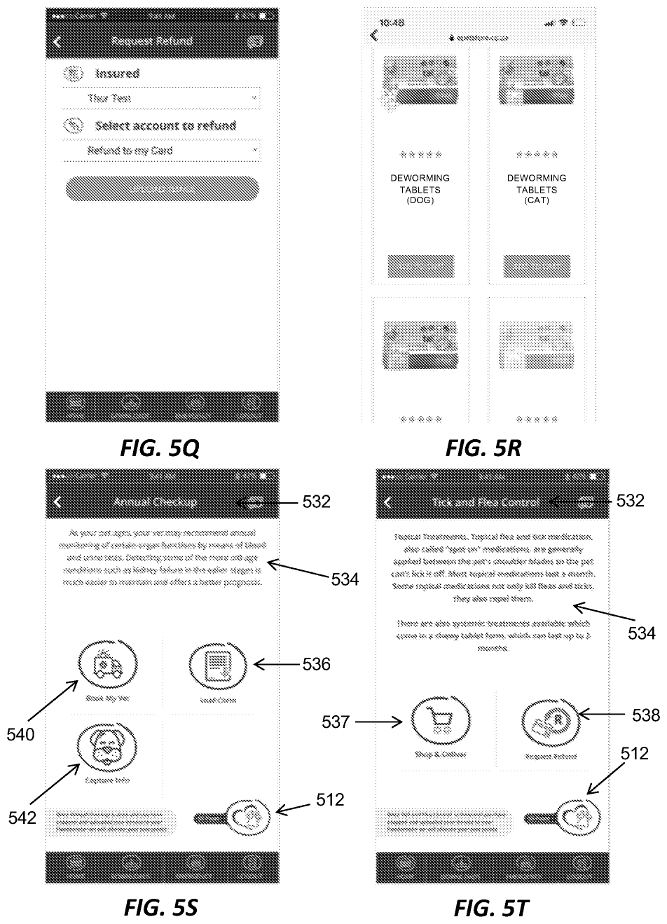

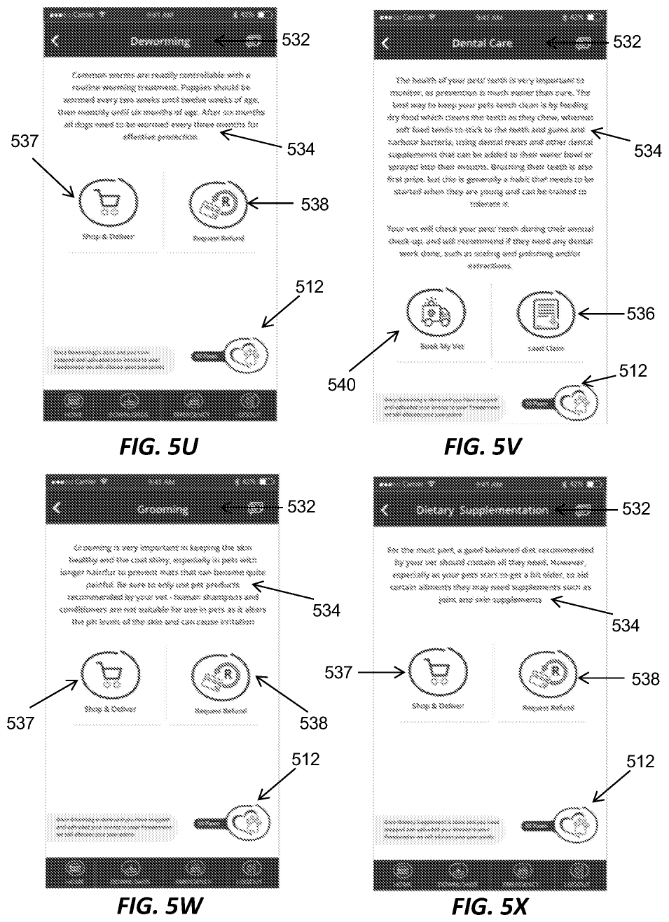

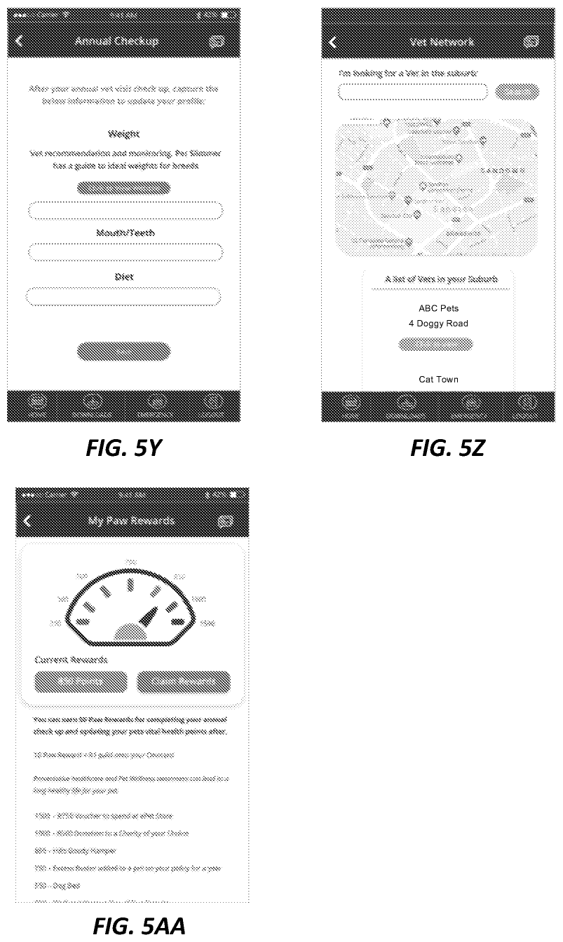

As described above with reference to FIG. 1, the pet wellness application may be provided by a software application which is resident and executing on the mobile computing device (110) of the user. FIGS. 5A to 5AA show an example embodiment of a graphical user interface for the pet wellness scheduling method and system provided by the software application.

For the purposes of this description, some of the functionality provided by the application will be discussed in no particular order. In other words, it should be appreciated that the functions elaborated on below do not have to be used by a user in sequential order, unless the description suggests otherwise.

FIG. 5A shows a home display of the graphical user interface for managing aspects of a pet wellness application for an enrolled user. The user interface provides the user with a plurality of categories to select which, upon selection, navigates the user to additional information associated with the particular category. The information associated with the particular category may be unique to the user and based on information provided by the user during the enrolment procedure, or which have been updated by the user after prolonged use of the pet wellness application. The categories to be selected may, for example, include one or more of: user information, including user personal details; user cover, including details on the insurance service plan to which the user is a member; claims, including insurance claim details; user uploads, such as supporting documentation for claims; vets, including a list of network vets based on a location of the computing device on which the application is executed; pet wellness, including information on pet wellness progression and/or allows a user to add an additional pet to the system; card and pin, including payment information and security details; chat, providing access to a chat functionality to discuss pet matters or resolve enquiries with authorised consultants.

It should be appreciated that alternative embodiments with different categories may be implemented. For example, some embodiments may include rewards categories, friend categories, fitness tracking categories or the like. It should further be appreciated that any number of categories may be displayed to the user and need not be limited to a specific number.

Accordingly, a user may navigate through the categories by selecting the category of interest. In order to view pet wellness progression and/or add an additional pet to the system, the user may select the pet wellness category (501).

An example embodiment of a user interface for the pet wellness category (501) is illustrated in FIG. 5B. As shown, the user may be provided with an option to add a new pet(s) (510), to view the wellness profile (511) of an already registered pet, or to view reward points/progress (512). Adding a new pet requires the user to input personal information associated with the pet via the user interface. The personal information may include attributes unique to the pet, such as the pet's name, type, breed, age, weight, and information relating to the pet's health/wellness, such as the date of the pet's previous vaccination, dental check-up, deworming cycle, or the like. The user may be required to input the attributes by selecting the desired option from a dropdown menu. This may mitigate the occurrence of errors in typing by the user and also guide the user as to the information which is required for each question/prompt. The pet subsequently added to the user profile and the user may select the relevant pet from the list of pets in the pet wellness category.

The user may submit the pet profile information, which is captured by the application and may be processed locally or sent to a backend server for processing. A wellness GUI wheel (520) is selected which appropriate to the pet profile from a selection of GUI wheels tailored to pet types and ages.

Upon selection of the relevant pet profile (511) from the pet wellness category, the user may be directed to a pet profile user interface (520) which shows some of the pet's information, such as the pet's name, date of birth, type, breed, weight and an image of the pet (if provided by the user).

The pet profile user interface further shows a wellness wheel (521) which has been calculated for the pet based on the information provided. FIGS. 5C and 5D show example embodiments of a pet profile user interface for different pet profiles.

The wellness wheel of each pet may progress based on completion of tasks associated with the respective wheel segments (522). The wellness wheel of each pet may also progress based on the age of the pet. In other words, there may be a wellness wheel having wheel segments based on the age or lifetime of the pet. For example, for the wellness wheel for a single pet may move between three stages during the pet's lifetime, such as: the puppy stage (the pet's first year); an adult stage; and a senior stage. Therefore, the wellness wheel may update based on the age of the pet and completion of tasks associated with a particular segment.

FIGS. 5E to 5G show example embodiments of pet wellness wheels based on the pet's age. FIG. 5E shows a wellness wheel for a pet during the pet's first year, and FIGS. 5F and 5G show wellness wheels for a pet during the pet's adult and senior years, respectively. In some embodiments the pet lifetime may be divided into one or more additional stages such as “puppy years”, “young adult years”, or the like.

As mentioned in the description above, each wellness wheel includes a series of segments that lead a user to progress around the wheel in a clockwise manner. Each segment provided by the wheel is associated with a wheel segment category that may be an appointment task, that ties to a veterinary network, an insurance policy, and a reward scheme, or a product application task, that ties to an e-commerce store, the insurance policy, and the reward scheme.

FIG. 5H to 50 show example embodiments or user interfaces associated with each segment provided by the wheel of a pet in its first-year stage. A user may select a segment by interacting with the GUI wheel component, which in turn displays a relevant task associated with the segment to be completed.

As shown in the FIGS. 5H to 50, each selected task includes a heading (532), a short description (534) or tips relating to the task, options (536) to load a claim, visit an e-commerce store (537), or request (538) a refund, and an indication (512) of the reward points associated with the particular task.

A user may select to load a claim for expenses incurred in completion of the task by selecting the option to load a claim. The user is then prompted to select the type of claim which is to be submitted and may be required to submit supporting documentation in support of the claim. The claim together with the supporting documentation will be sent to the server and/or insurer for processing. An example user interface of a claim submission page is shown in FIG. 5P.

Alternatively, a user may request a refund for expenses incurred in completion of the task. The user may be prompted to select an insurance policy, insurance savings account, or the like, against which the claim is to be refunded. The user may further be required to select the relevant account associated with the user to which the costs should be refunded. An example user interface of a refund request page is shown in FIG. 5Q.

In the event that the task associated with the wheel segment is a product application task, the user may select an option to purchase the relevant product from an e-store provided by the system. The user may simply select the relevant option from the user interface which would then direct the user to the appropriate e-store page. An example embodiment of the e-store user interface is shown in FIG. 5R.

Some tasks, such as dental care, yearly check-ups, or the like, may require a user to visit a veterinarian or other service provider. FIG. 5S to 5X show example embodiments of user interfaces associated with each segment provided by the wheel of a pet in its adult years stage. Similar to the user interfaces described with reference to FIGS. 5H to 50, a user may select a segment by interacting with the GUI wheel component, which in turn displays a relevant task associated with the segment to be completed. It is clear that the user interfaces have a similar display to FIGS. 5H to 50, however, the tasks associated with the segments of the GUI wheel differ, as is indicated by the heading (532) or a short description (534) of each task.

As mentioned above, some tasks, such as dental care and yearly check-ups shown in FIGS. 5S and 5V, respectively, require a user, and his/her pet, to visit a veterinarian or other service provider. The user interface associated with such tasks provides the user with an option (540) to book a veterinarian and subsequently search for a veterinarian based on a location provided by the user, or the location of the mobile computing device on which the application is executed. Depending on the booking system associated with the veterinarian, the user may simply be provided with contact details and a location of a veterinary nearby, be directed to a webpage of the veterinary, or prompted to schedule an online appointment. In some embodiments, only veterinarians supported by a selected insurance policy network may be suggested to the user. Alternatively, all veterinarians may be displayed to the user even if they do not form part of the insurance policy network. It should be appreciated that if a veterinarian which does not form part of the insurance policy network is visited, the user may not be able to submit a recovery claim, or the expenses incurred may only partially be recovered. The recovery procedures and terms and conditions would, of course, be provided to the user during enrolment or registration. An example embodiment of a veterinarian network search page is shown in FIG. 5Y.

After the annual check-up task, shown in FIG. 5S, has been completed, the user may be required to capture some of the information provided to the user during the check-up. The information may be used to update the pet profile accordingly. In order to capture the information, the user may select an information capture setting (542) on the user interface, which prompts the user to input information provided to the user during the check-up. An exemplary embodiment of the information capture page is shown in FIG. 5Z. The user may be required to manually provide the updated information or to select the correct option from a dropdown menu.

The user may at any time during the completion of tasks view his/her current accumulated reward points and claim rewards associated with the amount of reward points accumulated by selecting a reward category (512). FIG. 5AA shows an example embodiment of a reward page associated with a user profile. It should be appreciated that different reward systems may be implemented into the wellness scheduling system. For example, a user may be upgraded to a higher reward tier based on the number of pets registered onto the system, or based on a goal completion ration, for example. A higher tier may, for example, enable a user to earn more reward points and accordingly claim improved rewards. It should be appreciated that any suitable reward system may be implemented. It should be appreciated that the wellness wheel may also be updated as the pet profile is updated.

It should be appreciated that FIGS. 5A to 5AA simply show one example embodiment of a pet wellness scheduling application's user interface and that various different implementations may be implemented without deviating from the technical aspects of the invention. The invention should therefore not be limited to the features illustrated in FIGS. 5A to 5AA and the FIGS. merely provide a use case example.

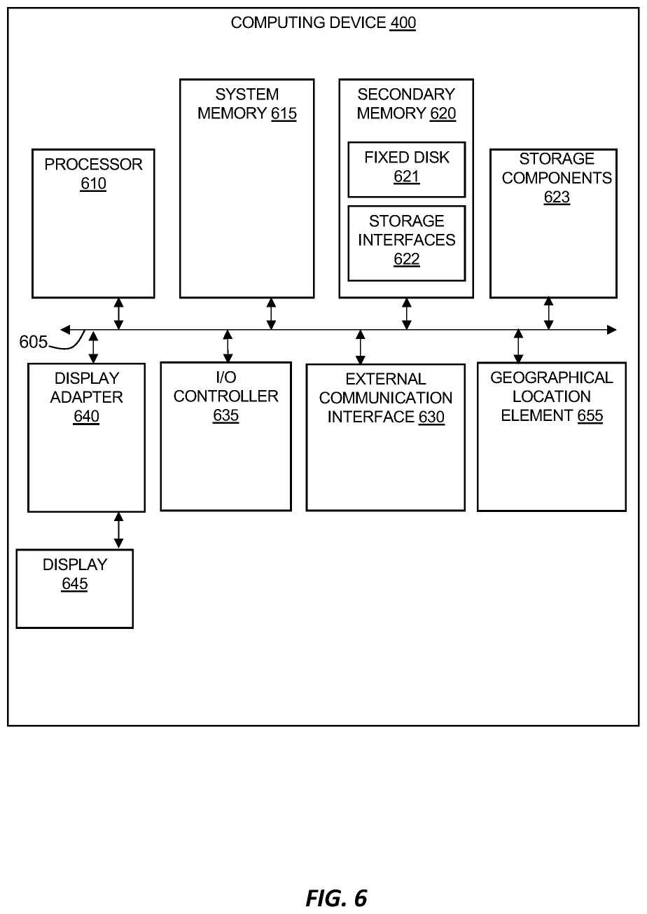

FIG. 6 illustrates an example of a computing device (600) in which various aspects of the disclosure may be implemented. The computing device (600) may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the computing device may dictate the inclusion or exclusion of various components or subsystems described below.

The computing device (600) may be suitable for storing and executing computer program code. The various participants and elements in the previously described system diagrams may use any suitable number of subsystems or components of the computing device (600) to facilitate the functions described herein. The computing device (600) may include subsystems or components interconnected via a communication infrastructure (605) (for example, a communications bus, a network, etc.). The computing device (600) may include one or more processors (610) and at least one memory component in the form of computer-readable media. The one or more processors (610) may include one or more of: CPUs, graphical processing units (GPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (600) may be distributed over a number of physical locations (e.g. in a distributed, cluster or cloud-based computing configuration) and appropriate software units may be arranged to manage and/or process data on behalf of remote devices.

The memory components may include system memory (615), which may include read only memory (ROM) and random access memory (RAM). A basic input/output system (BIOS) may be stored in ROM. System software may be stored in the system memory (615) including operating system software. The memory components may also include secondary memory (620). The secondary memory (620) may include a fixed disk (621), such as a hard disk drive, and, optionally, one or more storage interfaces (622) for interfacing with storage components (623), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (600) may include an external communications interface (630) for operation of the computing device (600) in a networked environment enabling transfer of data between multiple computing devices (600) and/or the Internet. Data transferred via the external communications interface (630) may be in the form of signals, which may be electronic, electromagnetic, optical, radio, or other types of signal. The external communications interface (630) may enable communication of data between the computing device (600) and other computing devices including servers and external storage facilities. Web services may be accessible by and/or from the computing device (600) via the communications interface (630).

The external communications interface (630) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry. The external communications interface (630) may include a subscriber identity module (SIM) in the form of an integrated circuit that stores an international mobile subscriber identity and the related key used to identify and authenticate a subscriber using the computing device (600). One or more subscriber identity modules may be removable from or embedded in the computing device (600).

The computer-readable media in the form of the various memory components may provide storage of computer-executable instructions, data structures, program modules, software units and other data. A computer program product may be provided by a computer-readable medium having stored computer-readable program code executable by the central processor (610). A computer program product may be provided by a non-transient or non-transitory computer-readable medium, or may be provided via a signal or other transient or transitory means via the communications interface (630).

Interconnection via the communication infrastructure (605) allows the one or more processors (610) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (600) either directly or via an I/O controller (635). One or more displays (645) (which may be touch-sensitive displays) may be coupled to or integrally formed with the computing device (600) via a display or video adapter (640).

The computing device (600) may include a geographical location element (655) which is arranged to determine the geographical location of the computing device (600). The geographical location element (655) may for example be implemented by way of a global positioning system (GPS), or similar, receiver module. In some implementations the geographical location element (655) may implement an indoor positioning system, using for example communication channels such as cellular telephone or Wi-Fi™ networks and/or beacons (e.g. Bluetooth™ Low Energy (BLE) beacons, iBeacons™, etc.) to determine or approximate the geographical location of the computing device (600). In some implementations, the geographical location element (655) may implement inertial navigation to track and determine the geographical location of the communication device using an initial set point and inertial measurement data.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. Components or devices configured or arranged to perform described functions or operations may be so arranged or configured through computer-implemented instructions which implement or carry out the described functions, algorithms, or methods. The computer-implemented instructions may be provided by hardware or software units. In one embodiment, a software unit is implemented with a computer program product comprising a non-transient or non-transitory computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the embodiments of the invention in terms of algorithms and symbolic representations of operations on information. These algorithmic descriptions and representations, such as accompanying flow diagrams, are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention set forth in any accompanying claims.

Finally, throughout the specification and any accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A computer-implemented method for scheduling pet wellness, comprising:
creating a pet profile including attributes configured to define a pet type and a pet age, wherein the pet profile is linked to a pet insurance service;
providing a graphical user interface component in the form of a wheel having a plurality of navigation segments, with each segment providing a category of a wellness task navigating to a task window, with the wheel component providing a progression around the wheel component by completion of the tasks in a recommended time period;
wherein the categories of wellness tasks include:
an appointment category that has a task window that navigates to a selection of approved wellness service providers required for a task; and
a product application category that has a task window that navigates to an e-commerce store for purchase of a required product for a task; and
wherein the task windows integrate to an insurance claim input for a cost of the service provider or purchased product.

2. The method as claimed in claim 1, wherein the wheel component represents a stage of life appropriate for the pet profile, with segments of the wheel component configured for the stage of life of the pet type.

3. The method as claimed in claim 2, including repeating a presentation of the wheel component of a stage of life appropriate for the pet profile according to an age provided in the pet profile.

4. The method as claimed in claim 2, including providing a next stage of life wheel component on completion of an earlier stage of life wheel and according to an age provided in the pet profile.

5. The method as claimed in claim 2, wherein the wheel component represents a first year of life and the appointment categories of wellness tasks include timed vaccination appointments.

6. The method as claimed in claim 1, including updating the pet profile after completion of a wellness task.

7. The method as claimed in claim 1, including integrating a reward scheme and including a reward after completion of a wellness task.

8. The method as claimed in claim 1, including navigating to a selection of approved wellness service providers required for a task based on a location service of a mobile device at which the method is carried out.

9. The method as claimed in claim 1, wherein an appointment category includes one or more of the group of: a health check appointment, a vaccination appointment, a preventative treatment appointment, a sterilization appointment, a dental appointment, and a therapy appointment.

10. The method as claimed in claim 1, wherein a product application category includes one or more of the group of: a topical anti-parasite product application, an internal anti-parasite product application, a grooming product application, a supplement product application.

11. A system for scheduling pet wellness, including a computing device including memory for storing computer-readable program code and a processor for executing the computer-readable program code, the computing device comprising:
a pet profile component for creating a pet profile including attributes configured to define a pet type and a pet age, wherein the pet profile is linked to a pet insurance service;
a graphical user interface wheel providing component for providing a graphical user interface component in the form of a wheel having a plurality of navigation segments, with each segment providing a category of a wellness task navigating to a task window, with the wheel component providing a progression around the wheel component by completion of the tasks in a recommended time period;
wherein the categories of wellness tasks include:
an appointment category provided by an appointment component that provides a task window that navigates to a selection of approved wellness service providers required for a task; and
a product application category provided by a product application component that provides a task window that navigates to an e-commerce store for purchase of a required product for a task; and
wherein the task windows integrate to an insurance claim component for input for a cost of the service provider or purchased product.

12. The system as claimed in claim 11, wherein the graphical user interface wheel component represents a stage of life appropriate for the pet profile, with segments of the wheel component configured for the stage of life of the pet type.

13. The system as claimed in claim 11, wherein the computing device includes a profile updating component for updating the pet profile after completion of a wellness task.

14. The system as claimed in claim 11, including one or more servers including a memory for storing computer-readable program code and a processor for executing the computer-readable program code, the one or more servers providing:
an insurance service component;
an e-commerce store service component; and
an approved wellness service provider network service component.

15. The system as claimed in claim 11, wherein the computing device includes a reward component for integrating a reward scheme and including a reward after completion of a wellness task.

16. The system as claimed in claim 15, including a server providing a rewards scheme service.

17. The system as claimed in claim 11, wherein the computing device includes a navigation component for providing navigating to a selection of approved wellness service providers required for a task based on a location service of a mobile device at which the method is carried out.

18. The system as claimed in claim 17, providing integration to a map server for providing lookup and navigation for the navigation component.

19. A computer program product for scheduling pet wellness comprising a computer-readable medium having stored computer-readable program code for performing the steps of:
creating a pet profile including attributes configured to define a pet type and a pet age, wherein the pet profile is linked to a pet insurance service;
providing a graphical user interface component in the form of a wheel component having a plurality of navigation segments, with each segment providing a category of a wellness task navigating to a task window, with the wheel component providing a progression around the wheel component by completion of the tasks in a recommended time period;
wherein the categories of wellness tasks include:
an appointment category that has a task window that navigates to a selection of approved wellness service providers required for a task; and
a product application category that has a task window that navigates to an e-commerce store for purchase of a required product for a task; and
wherein the task windows integrate to an insurance claim input for a cost of the service provider or purchased product.
